(19) United States
(12) Patent Application Publication
(10) Pub. No.: US 2026/0171306 A1
(43) Pub. Date: Jun. 18, 2026

(54) COMPOSITE ELECTRONIC COMPONENT AND BOARD FOR MOUNTING THE SAME

(71) Applicant: SAMSUNG ELECTRO-MECHANICS CO., LTD., Suwon-si (KR)

(72) Inventors: Sang Yeop Kim, Suwon-si (KR); Jung Mi Baek, Suwon-si (KR); Ki Hun Jeon, Suwon-si (KR); Ji Hun Lee, Suwon-si (KR)

(73) Assignee: SAMSUNG ELECTRO-MECHANICS CO., LTD., Suwon-si (KR)

(21) Appl. No.: 19/322,385

(22) Filed: Sep. 8, 2025

(30) Foreign Application Priority Data
Dec. 16, 2024 (KR) 10-2024-0186843

(51) Int. Cl. H01G 2/06; H01G 4/005; H01G 4/12; H01G 4/232; H01G 4/30

(52) U.S. Cl. CPC H01G 2/06; H01G 4/12; H01G 4/232; H01G 4/30; H01G 4/005

(57) ABSTRACT

A composite electronic component includes a multilayer electronic component including a body including a dielectric layer and internal electrodes alternately disposed with the dielectric layer in a first direction, and first and second external electrodes disposed on the body; a metal frame including a connection portion disposed on the external electrode and a support portion connected to the connection portion, wherein, when a length of the multilayer electronic component is defined as L and a width is defined as W, W²≤A1 and W²≤A2 is satisfied.

### CROSS-REFERENCE TO RELATED APPLICATION(S)

This application claims benefit of priority to Korean Patent Application No. 10-2024-0186843 filed on Dec. 16, 2024 in the Korean Intellectual Property Office, the disclosure of which is incorporated herein by reference in its entirety.

### BACKGROUND

### 1. Technical Field

The present disclosure relates to a composite electronic component and a board for mounting the composite electronic component.

### 2. Description of Related Art

A multilayer ceramic capacitor (MLCC), a multilayer electronic component, may be a chip condenser mounted on the printed circuit boards of various electronic products including image display devices such as a liquid crystal display (LCD) and a plasma display panel (PDP), a computer, a smartphone, a mobile phone, or the like, and charging or discharging electricity therein or therefrom.

Such a multilayer ceramic capacitor may be used as a component of various electronic devices, since a multilayer ceramic capacitor may have a small size and high capacitance and may be easily mounted. As various electronic devices such as a computer and a mobile device have been designed to have a smaller size and higher output, demand for miniaturization and increased capacitance of a multilayer ceramic capacitor has increased.

Such a multilayer ceramic capacitor has recently been applied to a power drive system in automobiles, and multilayer ceramic capacitors for automobiles may be required to have excellent high-temperature reliability, moisture-resistant reliability, and impact resistance. Particularly, cracks may occur in a ceramic body due to external impact, acoustic noise, or warpage stress, which may cause component failure. To compensate therefore, impact resistance of the component may be improved by attaching a frame such as metal to an external electrode to alleviate external impact.

However, in the case of an ultra-small component, a mounting area of the frame may be insufficient, such that it may be difficult to fix to a substrate, and current lines may be generated at both ends of the component to which different voltages are applied, such that current loss may occur or equivalent series resistance (ESR) may increase. Thus, a structural design of a frame having excellent mounting strength in an ultra-small component and a low ESR and improving impact resistance may be necessary.

### SUMMARY

An embodiment of the present disclosure is to provide a composite electronic component having improved warpage strength.

An embodiment of the present disclosure is to provide a composite electronic component having an optimal mounting area.

An embodiment of the present disclosure is to provide a composite electronic component having optimal equivalent series resistance (ESR).

An embodiment of the present disclosure is to provide a composite electronic component having reduced acoustic noise.

According to an embodiment of the present disclosure, a composite electronic component includes a multilayer electronic component including a body including a dielectric layer and internal electrodes alternately disposed with the dielectric layer in a first direction, and first and second surfaces opposing each other in the first direction, third and fourth surfaces connected to the first and second surfaces and opposing each other in a second direction, fifth and sixth surfaces connected to the first to fourth surfaces and opposing each other in a third direction, and first and second external electrodes disposed on the third and fourth surfaces, respectively; a first metal frame including a first connection portion disposed on the first external electrode, and a first support portion connected to the first connection portion and spaced apart from the first surface; and a second metal frame including a second connection portion disposed on the second external electrode, and a second support portion connected to the second connection portion and spaced apart from the first surface, wherein, when an average dimension, in the second direction, of the multilayer electronic component is defined as L and an average dimension, in the third direction, of the multilayer electronic component is defined as W, L≤0.4 mm, W≤0.2 mm is satisfied, and wherein, when an area of the first support portion is defined as A1 and an area of the second support portion is defined as A2, W²≤A1 and W²≤A2 is satisfied.

According to an embodiment of the present disclosure, a composite electronic component includes a multilayer electronic component including a body including a dielectric layer and internal electrodes alternately disposed with the dielectric layer in a first direction, and first and second surfaces opposing each other in the first direction, third and fourth surfaces connected to the first and second surfaces and opposing each other in a second direction, fifth and sixth surfaces connected to the first to fourth surfaces and opposing each other in a third direction, and first and second external electrodes disposed on the third and fourth surfaces, respectively; a first metal frame including a first connection portion disposed on the first external electrode, and a first support portion connected to the first connection portion and spaced apart from the first surface; and a second metal frame including a second connection portion disposed on the second external electrode, and a second support portion connected to the second connection portion and spaced apart from the first surface, wherein, when an average dimension, in the second direction, of the multilayer electronic component is defined as L and an average dimension, in the third direction, of the multilayer electronic component is defined as W, L≤0.4 mm, W≤0.2 mm is satisfied, and wherein, when an average dimension, in the second direction, of the first support portion is defined as L1, an average dimension, in the third direction, of the first support portion is defined as W1, an average dimension, in the second direction, of the second support portion is defined as L2, and an average dimension, in the third direction, of the second support portion is defined as W², W²≤L1×W1 and W²≤L2×W² is satisfied.

According to an embodiment of the present disclosure, a board for mounting the composite electronic component includes a board; first and second electrode pads disposed on the board; and the composite electronic component, wherein the first and second support portions are mounted on the board to be bonded to the first and second electrode pads, respectively.

### BRIEF DESCRIPTION OF DRAWINGS

The and other aspects, features, and advantages of the present disclosure will be more clearly understood from the following detailed description, taken in combination with the accompanying drawings, in which:

FIG. 1 is a perspective diagram illustrating a composite electronic component according to an embodiment of the present disclosure;

FIG. 2 is a cross-sectional diagram taken along line I-I′ in FIG. 1;

FIG. 3 is a diagram illustrating a composite electronic component according to an embodiment of the present disclosure, viewed from below;

FIGS. 4 to 7 are cross-sectional diagrams illustrating a composite electronic component taken along line I-I′ according to other embodiments of the present disclosure;

FIG. 8 is a perspective diagram illustrating a composite electronic component according to another embodiment of the present disclosure;

FIGS. 9 and 10 are cross-sectional diagrams illustrating a composite electronic component taken along line I-I′ according to other embodiments of the present disclosure; and

FIG. 11 is a perspective diagram illustrating a board for mounting the composite electronic component illustrated in FIG. 1, in which a composite electronic component is mounted according to an embodiment of the present disclosure.

### DETAILED DESCRIPTION

Hereinafter, embodiments of the present disclosure will be described as below with reference to the accompanying drawings.

These embodiments are described in sufficient detail to enable those skilled in the art to practice the disclosure. It is to be understood that the various embodiments of the disclosure, although different, are not necessarily mutually exclusive. For example, structures, shapes, and sizes described as examples in embodiments in the present disclosure may be implemented in another embodiment without departing from the spirit and scope of the present disclosure. Further, modifications of positions or arrangements of elements in embodiments may be made without departing from the spirit and scope of the present disclosure. The following detailed description is, accordingly, not to be taken in a limiting sense, and the scope of the present disclosure are defined only by appended claims, appropriately interpreted, along with the full range of equivalents to which the claims are entitled.

In the drawings, same elements will be indicated by same reference numerals. Also, redundant descriptions and detailed descriptions of known functions and elements which may unnecessarily render the gist of the present disclosure obscure will be omitted. In the accompanying drawings, some elements may be exaggerated, omitted or briefly illustrated, and the sizes of the elements do not necessarily reflect the actual sizes of these elements. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

In the drawings, the Z direction may be defined as the first direction, the lamination direction or the thickness T direction, the X direction may be defined as the second direction or the length L direction, and the Y direction may be defined as the third direction or the width W direction.

### Composite Electronic Component

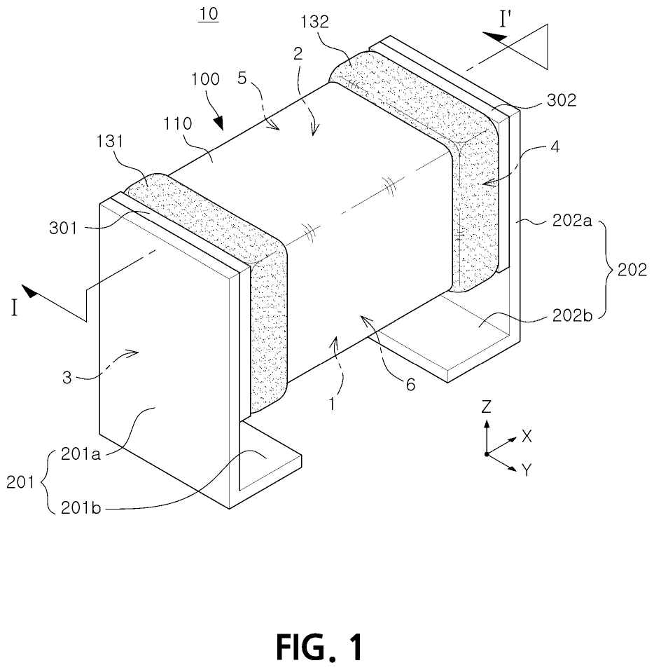

FIG. 1 is a perspective diagram illustrating a composite electronic component according to an embodiment.

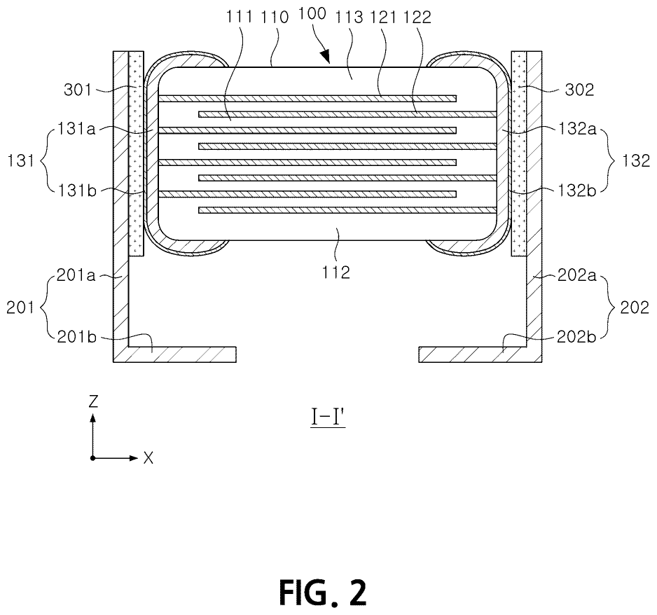

FIG. 2 is a cross-sectional diagram taken along line I-I′ in FIG. 1.

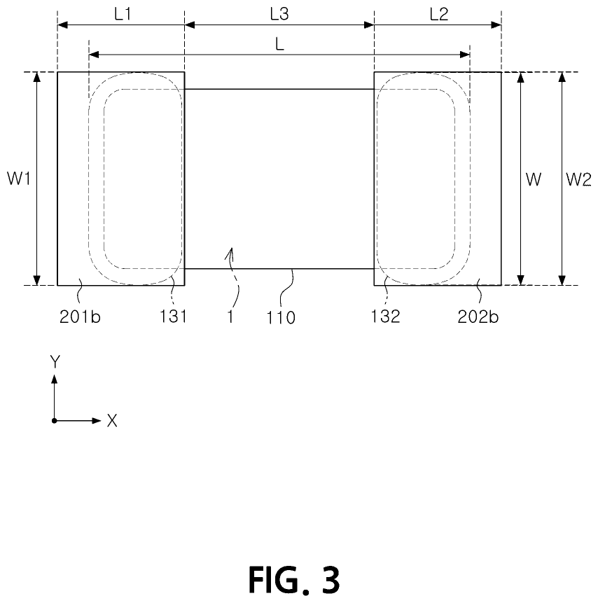

FIG. 3 is a diagram illustrating a composite electronic component according to an embodiment, viewed from below

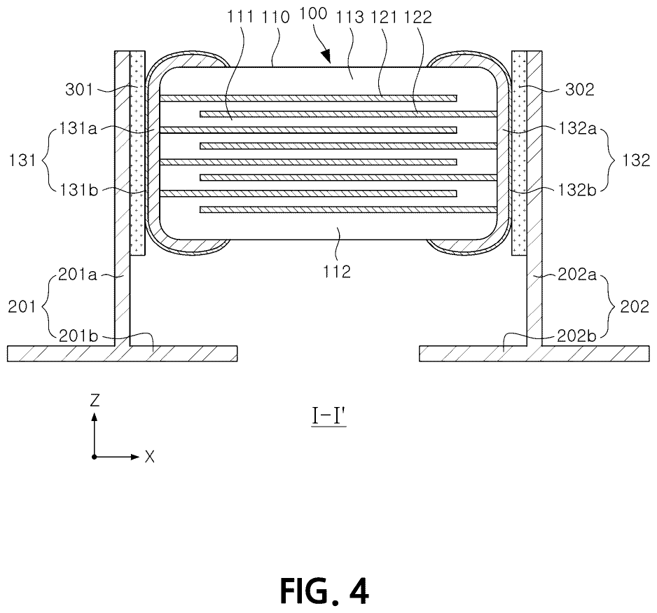

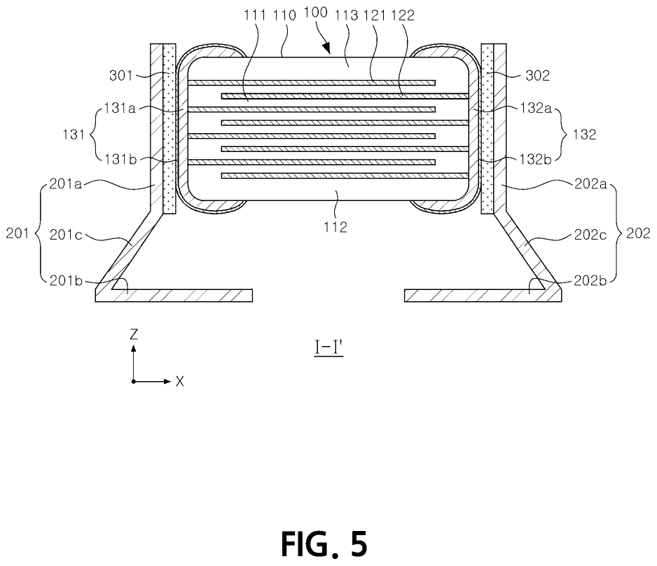

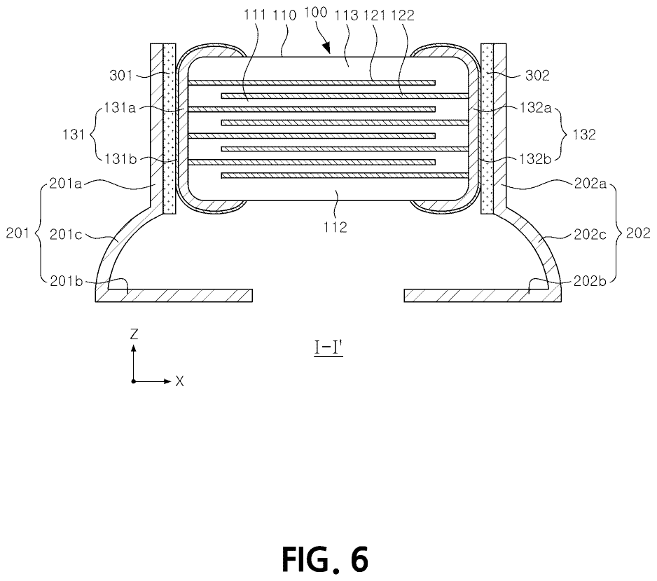

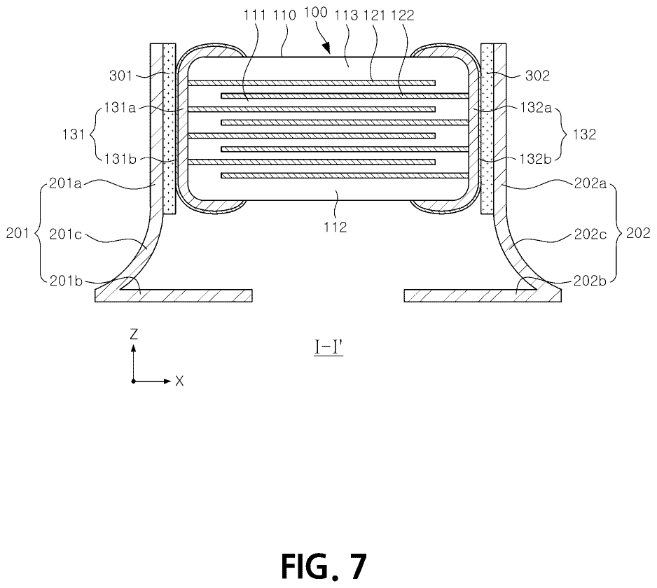

FIGS. 4 to 7 are cross-sectional diagrams illustrating a composite electronic component taken along line I-I′ according to other embodiments.

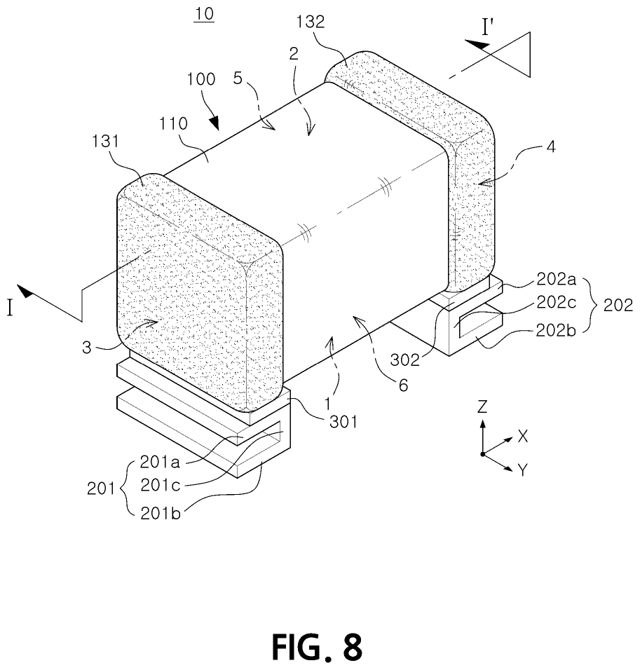

FIG. 8 is a perspective diagram illustrating a composite electronic component according to another embodiment.

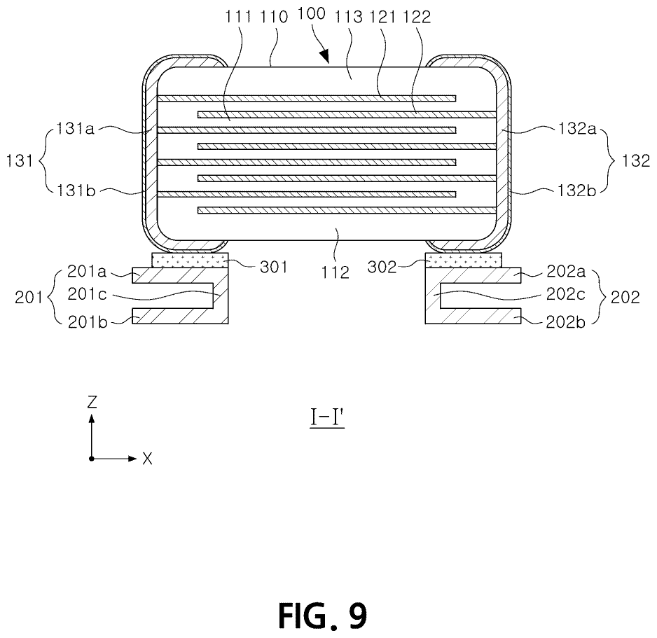

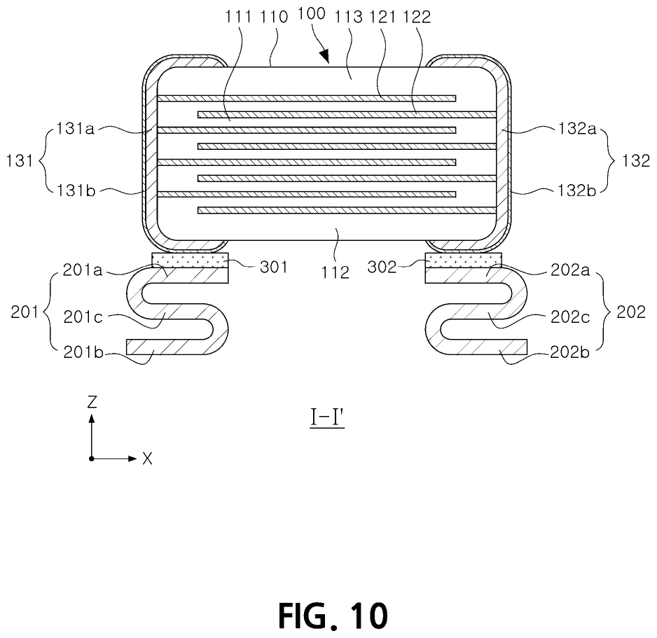

FIGS. 9 and 10 are cross-sectional diagrams illustrating a composite electronic component taken along line I-I′ according to other embodiments.

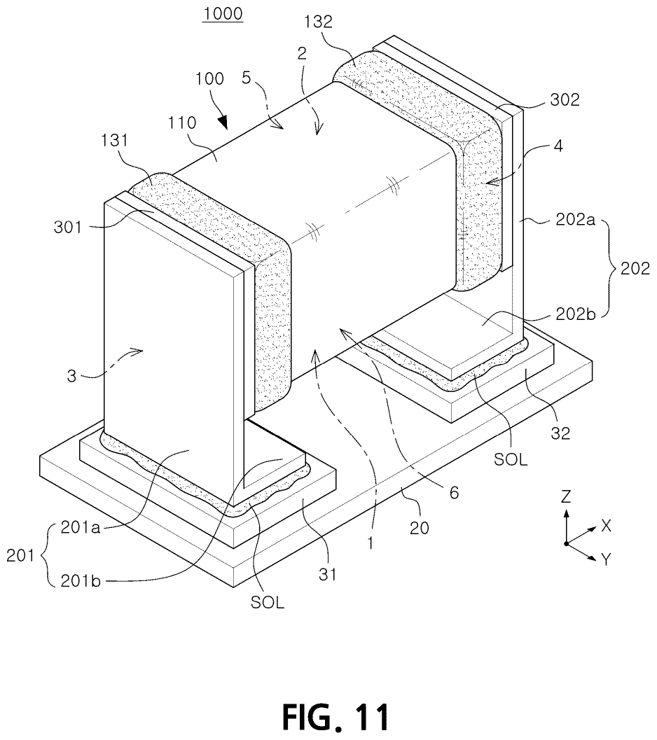

FIG. 11 is a perspective diagram illustrating a board for mounting the composite electronic component illustrated in FIG. 1, in which a composite electronic component is mounted.

Hereinafter, a composite electronic component and a board for mounting the composite electronic component according to an embodiment will be described in greater detail with reference to FIGS. 1 to 11. A multilayer ceramic capacitor will be described as an example of a multilayer electronic component, but the present disclosure may also be applied to various electronic products using a dielectric composition, such as an inductor, a piezoelectric element, a varistor, or a thermistor.

A composite electronic component 10 according to an embodiment may include a multilayer electronic component including a body including a dielectric layer 111 and internal electrodes 121 and 122 alternately disposed with the dielectric layer 111 in a first direction, and first and second surfaces 1 and 2 opposing each other in the first direction, third and fourth surfaces 3 and 4 connected to the first and second surfaces 1 and 2 and opposing each other in a second direction, fifth and sixth surfaces 5 and 6 connected to the first to fourth surfaces 1, 2, 3 and 4 and opposing each other in a third direction, and first and second external electrodes 131 and 132 disposed on the third and fourth surfaces 3 and 4, respectively; a first metal frame 201 including a first connection portion 201a disposed on the first external electrode 131, and a first support portion 201b connected to the first connection portion 201a and spaced apart from the first surface 1; and a second metal frame 202 including a second connection portion 202a disposed on the second external electrode 132, and a second support portion 202b connected to the second connection portion 202a and spaced apart from the first surface 1, wherein, when an average dimension in the second direction of the multilayer electronic component 100 is defined as L and an average dimension in the third direction is defined as W, L≤0.4 mm, W≤0.2 mm is satisfied, and wherein, when an area of the first support portion 201b is defined as A1 and an area of the second support portion 202b is defined as A2, W²≤A1 and W²≤A2 may be satisfied.

Also, when an average dimension in the second direction of the first support portion 201b is defined as L1, an average dimension in the third direction is defined as W1, an average dimension in the second direction of the second support portion 202b is defined as L2, and an average dimension in the third direction is defined as W2, W²<L1×W1 and W²≤L2×W² may be satisfied.

The multilayer electronic component 100 may include the body 110 and the external electrodes 131 and 132 disposed on the body 110.

In the body 110, the dielectric layer 111 and the internal electrodes 121 and 122 may be laminated alternately.

More specifically, the body 110 may include a capacitance formation portion Ac forming capacitance, disposed in the body 110 and including a first internal electrode 121 and a second internal electrode 122 disposed alternately to oppose each other with the dielectric layer 111 interposed therebetween.

The shape of the body 110 may not be limited to any particular shape, but as illustrated, the body 110 may have a hexahedral shape or a shape similar to a hexahedral shape. Due to reduction of ceramic powder included in the body 110 during a firing process, the body 110 may not have an exactly hexahedral shape formed by linear lines but may have a substantially hexahedral shape.

The body 110 may have the first and second surfaces 1 and 2 opposing each other in the first direction, the third and fourth surfaces 3 and 4 connected to the first and second surfaces 1 and 2 and opposing in the second direction, and the fifth and sixth surfaces 5 and 6 connected to the first to fourth surfaces 1, 2, 3, and 4 and opposing each other in the third direction.

The plurality of dielectric layers 111 forming the body 110 may be in a fired state, and boundaries between the adjacent dielectric layers 111 may be integrated with each other such that the boundaries may not be distinct without using a scanning electron microscope (SEM).

The raw material forming the dielectric layer 111 is not limited as long as sufficient capacitance may be obtained therewith, and generally, a perovskite (ABO₃) material may be used, and for example, a barium titanate material, a lead composite perovskite material, or a strontium titanate material may be used. A barium titanate material may include BaTiO₃ ceramic particles, and an example of the ceramic powder may include BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1) or Ba(Ti_{1-y}Zr_{y})O₃ (0<y<1) in which Ca (calcium) and Zr (zirconium) are partially dissolved.

Also, as a raw material for forming the dielectric layer 111, various ceramic additives, organic solvents, binders, and dispersants may be added to particles such as barium titanate (BaTiO₃) depending on the purpose of the embodiment.

To be distinguished from the dielectric layer included in the cover portions 112 and 113 and the side margin portion described below, the dielectric layer included in the capacitance formation portion Ac may be defined as a first dielectric layer, the dielectric layer included in the cover portions 112 and 113 may be defined as a second dielectric layer, and the dielectric layer included in the side margin portion may be defined as a third dielectric layer.

Also, the first to third dielectric layers may be formed using ceramic or dielectric material such as barium titanate (BaTiO₃), such that the first to third dielectric layers may include a dielectric microstructure after sintering. The dielectric microstructure may include a plurality of grains, grain boundaries disposed between adjacent grains, and triple points disposed at points at which three or more grain boundaries meet, and may include a plurality of grains, a plurality of grain boundaries, and a plurality of triple points.

The dimension td in the first direction of the dielectric layer 111 may not need to be limited to any particular example.

However, to easily obtain miniaturization and high capacitance of the multilayer electronic component 100, the dimension td in the first direction of the dielectric layer 111 may be 1.0 μm or less, 0.8 μm or less, preferably 0.6 μm or less, or more preferably 0.4 μm or less.

Here, the dimension td in the first direction of the dielectric layer 111 may indicate the dimension td in the first direction of the dielectric layer 111 disposed between the first and second internal electrodes 121 and 122.

The dimension td in the first direction of the dielectric layer 111 may indicate the dimension, distance, size, or length of the dielectric layer 111 in the first direction, or may indicate the thickness of the dielectric layer.

In this case, the dimension td in the first direction of the dielectric layer 111 may include the dimension td in the first direction of at least one of a plurality of dielectric layers 111, or may include the dimension td in the first direction of each of the entirety of dielectric layers 111.

Also, the dimension td in the first direction of the dielectric layer 111 may indicate the average dimension td in the first direction of one dielectric layer 111, may indicate the average dimension td in the first direction of each of the plurality of dielectric layers 111, or may indicate the average dimension td in the first direction of the plurality of dielectric layers 111.

The average dimension td in the first direction of the dielectric layer 111 may be measured by scanning a cross-section of the body 110 in the first and second directions using a scanning electron microscope (SEM) at 10,000× magnification. More specifically, the average dimension td in the first direction of one dielectric layer 111 may indicate an average value calculated by measuring the dimension in the first direction at five points at an equal distance in one dielectric layer 111 in the second direction in the scanned image. The five points at an equal distance may be specified in the capacitance formation portion Ac. Also, by extending the average value measurement to three dielectric layers 111 and measuring an average value, the average dimension td in the first direction of the plurality of dielectric layers 111 may be further generalized.

The internal electrodes 121 and 122 may be laminated alternately with the dielectric layer 111.

The internal electrodes 121 and 122 may include a first internal electrode 121 and a second internal electrode 122, and the first and second internal electrodes 121 and 122 may be disposed alternately so as to oppose each other with the dielectric layer 111 included in the body 110 interposed therebetween, and may be exposed to the third and fourth surfaces 3 and 4 of the body 110, respectively.

More specifically, the first internal electrode 121 may be spaced apart from the fourth surface 4 and may be exposed through the third surface 3, and the second internal electrode 122 may be spaced apart from the third surface 3 and may be exposed through the fourth surface 4. The first external electrode 131 may be disposed on the third surface 3 of the body 110 and may be connected to the first internal electrode 121, and the second external electrode 132 may be disposed on the fourth surface 4 of the body 110 and may be connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. In this case, the first and second internal electrodes 121 and 122 may be electrically isolated from each other by the dielectric layer 111 disposed therebetween.

The body 110 may be formed by alternately laminating a first ceramic green sheet on which a paste for the first internal electrode is printed, which becomes the first internal electrode 121, and a second ceramic green sheet on which a paste for the second internal electrode is printed, which becomes the second internal electrode 122, and firing the sheets.

The material for forming the internal electrodes 121 and 122 is not limited to any particular example, and a material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

Also, the internal electrodes 121 and 122 may be formed by printing a conductive paste for internal electrodes including one or more of nickel (Ni), copper (Cu), palladium (Pd), silver (Ag), gold (Au), platinum (Pt), tin (Sn), tungsten (W), titanium (Ti), and alloys thereof on a ceramic green sheet. As the method of printing the conductive paste for internal electrodes, a screen-printing method or a gravure printing method may be used, but an embodiment thereof is not limited thereto.

The dimension the in the first direction of the internal electrodes 121 and 122 may not be limited to any particular example, and the description of the dimension the in the first direction of the internal electrodes 121 and 122 below may indicate the dimension the in the first direction of each of the first internal electrode 121 and the second internal electrode 122.

To obtain miniaturization and high capacitance of the multilayer electronic component 100, the dimension the in the first direction of the internal electrodes 121 and 122 may be 1.0 μm or less. To easily obtain ultra-miniaturization and high capacitance, the dimension the in the first direction of the internal electrodes 121 and 122 may be 0.8 μm or less or 0.6 μm or less, and more preferably 0.4 μm or less.

In this case, the dimension the in the first direction of the internal electrodes 121 and 122 may include at least one dimension the in the first direction among the plurality of internal electrodes 121 and 122, or may include the dimensions the in the first direction of the entirety of the internal electrodes 121 and 122.

Here, the dimension the in the first direction of the internal electrodes 121 and 122 may indicate a dimension, distance, size, or length in the first direction of the internal electrodes 121 and 122, or may indicate a thickness of the internal electrodes 121 and 122.

In this case, the dimension the in the first direction of the internal electrodes 121 and 122 may include at least one dimension the in the first direction among the plurality of internal electrodes 121 and 122, or may include the dimension the in the first direction of each of the entirety of the internal electrodes 121 and 122.

Also, the dimension the in the first direction of the internal electrodes 121 and 122 may indicate an average dimension the in the first direction of one of the internal electrodes 121 and 122, or may indicate an average dimension the in the first direction of each of the plurality of internal electrodes 121 and 122, or may indicate an average dimension the in the first direction of the plurality of internal electrodes 121 and 122.

The average dimension the in the first direction of the internal electrodes 121 and 122 may be measured by scanning a cross-section in the first and second directions of the body 110 using a scanning electron microscope (SEM) at 10,000× magnification. More specifically, the first average dimension the of one of the internal electrodes 121 and 122 may be an average value calculated by measuring the dimension in the first direction of one of the internal electrodes at five points at an equal distance in the second direction in the scanned image. Five points at an equal distance may be specified in the capacitance formation portion Ac. Also, by extending the average value measurement to three internal electrodes 121 and 122 and measuring the average value, the average dimension the in the first direction of the plurality of internal electrodes 121 and 122 may be further generalized.

The body 110 may include cover portions 112 and 113 disposed on both end-surfaces in the first direction of the capacitance formation portion Ac.

Specifically, the body may include a first cover portion 112 disposed on one surface of the capacitance formation portion Ac in the first direction and a second cover portion 113 disposed on the other surface of the capacitance formation portion Ac in the first direction. More specifically, for example, the body may include a first cover portion 112 disposed on a lower portion in the first direction of the capacitance formation portion Ac and a second cover portion 113 disposed on an upper portion in the first direction of the capacitance formation portion Ac.

The first cover portion 112 and the second cover portion 113 may be formed by disposing or laminating a single second dielectric layer or two or more second dielectric layers on upper and lower surfaces in the first direction of the capacitance formation portion Ac, respectively, and may prevent damage to the internal electrodes 121 and 122 due to physical or chemical stress.

The first cover portion 112 and the second cover portion 113 may not include the internal electrodes 121 and 122, and may include a dielectric material the same as the first dielectric layer 111 of the capacitance formation portion Ac. That is, the first cover portion 112 and the second cover portion 113 may include a dielectric material, and may include, for example, a barium titanate (BaTiO₃) dielectric material.

The dimension tc in the first direction of the cover portions 112 and 113 may not be limited to any particular example, and the description of the dimension tc in the first direction of the cover portions 112 and 113 below may indicate the dimension tc in the first direction of each of the first cover portion 112 and the second cover portion 113.

However, to easily obtain miniaturization and high capacitance of the multilayer electronic component 100, the dimension tc in the first direction of the cover portions 112 and 113 may be 50 μm or less or 40 μm or less, or preferably 30 μm or less, and in an ultra-small product, more preferably, 20 μm or less, 15 μm or less, or 10 μm or less.

Here, the dimension tc in the first direction of the cover portions 112 and 113 may indicate the dimension in the first direction of the cover portions 112 and 113.

Also, the dimension tc in the first direction of the cover portions 112 and 113 may indicate the average dimension tc in the first direction of each of the first and second cover portions 112 and 113, or may indicate the average dimension tc in the first direction of the first and second cover portions 112 and 113.

The average dimension tc in the first direction of the cover portions 112 and 113 may be measured by scanning a cross-section in the first and second directions of the body 110 using a scanning electron microscope (SEM) at 10,000× magnification. More specifically, the average dimension may be the average value calculated by measuring the dimension in the first direction at five points at an equal distance in the second direction in the scanned image of one of the cover portions 112 and 113.

Also, the average dimension tc in the first direction of the cover portions 112 and 113 measured by the above-described method may have substantially the same value as the average dimension in the first direction of the cover portions 112 and 113 in the cross-section in the first and third directions of the body 110.

The multilayer electronic component 100 may include a side margin region, which is an end region in the third direction of the internal electrodes 121 and 122.

More specifically, the side margin region may include a first side margin region disposed between the internal electrodes 121 and 122 and the fifth surface 5, and a second side margin region disposed between the internal electrodes 121 and 122 and the sixth surface 6.

The side margin region may indicate a region between both ends in the third direction of the first and second internal electrodes 121 and 122 and the boundary surface of the body 110 based on the cross-section in the first and third directions of the body 110 as illustrated.

The side margin region may indicate a region of the ceramic green sheet other than the internal electrodes 121 and 122 when the paste for the internal electrode is applied to the ceramic green sheet applied to the capacitance formation portion Ac except for the region becoming the side margin region.

The side margin region may prevent damage to the internal electrode due to physical or chemical stress.

The first side margin region and the second side margin region may not include the internal electrodes 121 and 122, may include the same material as the first dielectric layer 111, and may correspond to a portion of the first dielectric layer 111, for example. That is, the first side margin region and the second side margin region may include a dielectric material, and may include, for example, a barium titanate (BaTiO₃) dielectric material.

The dimension in the third direction of the side margin region may not be limited to any particular example, and hereinafter, the description of the dimension in the third direction of the side margin region may indicate the dimension in the third direction of each of the first side margin region and the second side margin region.

To easily obtain miniaturization and high capacitance of the multilayer electronic component 100, the dimension in the third direction of the side margin region may be 30 μm or less, and in an ultra-small product, preferably, 20 μm or less, 15 μm or less, or 10 μm or less.

Here, the dimension in the third direction of the side margin region may indicate the dimension, distance, size, or length in the third direction of the side margin region, or may indicate the width of the side margin region.

Also, the dimension in the third direction of the side margin region may indicate the average dimension in the third direction of each of the first and second side margin regions, or may indicate the average dimension in the third direction of the first and second side margin regions.

The average dimension in the third direction of the side margin region may be measured by scanning a cross-section in the first and third directions of the body 110 using a scanning electron microscope (SEM) at 10,000× magnification. More specifically, the average dimension may be the average value calculated by measuring the dimension in the third direction at five points at an equal distance in the first direction in the scanned image of one side margin region.

The multilayer electronic component 100 may include a side margin portion disposed on both end-surfaces in the third direction of the body 110.

More specifically, the side margin portion may include a first side margin portion disposed on the fifth surface 5 of the body 110 and a second side margin portion disposed on the sixth surface 6 of the body 110.

The side margin portion may be formed by applying conductive paste to the ceramic green sheet applied to the capacitance formation portion Ac other than the region in which the side margin portion is to be formed, cutting such that the internal electrodes 121 and 122 after lamination are exposed to the fifth and sixth surfaces 5 and 6 of the body 110 to suppress a step difference by the internal electrodes 121 and 122, and disposing or laminating a third dielectric layer or two or more third dielectric layers in the third direction on both end-surfaces of the capacitance formation portion Ac.

The side margin portion may prevent damage to the internal electrodes 121 and 122 caused by physical or chemical stress.

The first side margin portion and the second side margin portion may not include the internal electrodes 121 and 122, and may include the same material as the first dielectric layer 111. That is, the first side margin portion and the second side margin portion may include a dielectric material, for example, a barium titanate (BaTiO₃) dielectric material.

The dimension in the third direction of the side margin portion may not be limited to any particular example, and hereinafter, the description of the dimension in the third direction of the side margin portion may indicate the dimension in the third direction of each of the first side margin portion and the second side margin portion.

However, to easily obtain miniaturization and high capacitance of the multilayer electronic component 100, the dimension in the third direction of the side margin portion may be 30 μm or less, and in an ultra-small product, preferably, 20 μm or less, 15 μm or less, or 10 μm or less.

Here, the dimension in the third direction of the side margin portion may indicate a dimension, distance, size, or length of the side margin portion in the third direction, or may indicate a width of the side margin portion.

Also, the dimension in the third direction of the side margin portion may indicate an average dimension in the third direction of each of the first and second side margin portions, or may indicate an average dimension in the third direction of the first and second side margin portions.

The average dimension in the third direction of the side margin portion may be measured by scanning a cross-section in the first and third directions of the body 110 using a scanning electron microscope (SEM) at 10,000× magnification. More specifically, the average dimension may indicate the average value calculated by measuring the dimension in the third direction at five points at an equal distance in the first direction in the scanned image of one side margin portion.

In an embodiment, the multilayer electronic component 100 includes two external electrodes 131 and 132, but the number or the shape of the external electrodes 131 and 132 may be changed depending on the shape of the internal electrodes 121 and 122 or other purposes.

The external electrodes 131 and 132 may be disposed on the body 110 and may be connected to the internal electrodes 121 and 122.

More specifically, the external electrodes 131 and 132 may be disposed on the third and fourth surfaces 3 and 4 of the body 110, respectively, and may include the first and second external electrodes 131 and 132 connected to the first and second internal electrodes 121 and 122, respectively. That is, the first external electrode 131 may be disposed on the third surface 3 of the body and may be connected to the first internal electrode 121, and the second external electrode 132 may be disposed on the fourth surface 4 of the body and may be connected to the second internal electrode 122.

Also, the external electrodes 131 and 132 may extend to a portion of the first and second surfaces 1 and 2 of the body 110, or may extend to a portion of the fifth and sixth surfaces 5 and 6 of the body 110. That is, the first external electrode 131 may be disposed on the third surface 3 of the body 110 and a portion of the first, second, fifth, sixth surfaces 1, 2, 5, and 6 of the body 110, and the second external electrode 132 may be disposed on the fourth surface 4 of the body 110 and a portion of the first, second, fifth, and sixth surfaces 1, 2, 5, and 6 of the body 110.

The external electrodes 131 and 132 may be formed using any electrically conductive, such as a metal, and the specific material may be determined by considering electrical properties, structural stability, or the like, and the external electrodes 131 and 132 may also have a multilayer structure.

For example, the external electrodes 131 and 132 may include first electrode layers 131a and 131b disposed on the body 110, and second electrode layers 131b and 132b disposed on the first electrode layers 131a and 132a.

Here, preferably, the first and second electrode layers 131a, 132a, 131b, and 132b may be distinct from each other. However, an embodiment thereof is not limited thereto, and the first and second electrode layers 131a, 132a, 131b, and 132b may be distinguished depending on the manufacturing process sequence, and the first and second electrode layers 131a, 132a, 131b, and 132b may not be distinct from each other and may be observed as an integrated layer.

In the present disclosure, “being distinct may indicate that two layers are distinguished from each other due to physical difference, chemical difference, and/or simple optical difference, but an embodiment thereof is not limited thereto, and the layers may be distinct from each other by the presence or absence of an “interfacial surface.” An interfacial surface may indicate a surface in which two layers in contact with each other are distinct from each other, and may indicate a state in which the layers are distinct, for example, through differences in components through EDS analysis using a device such as a scanning electron microscope (SEM).

The first electrode layers 131a and 132a may be formed by transferring a sheet including a conductive metal onto the body 110, or by applying a conductive paste for an external electrode including a conductive metal to the body 110 and firing the sheet, or by dipping the body 110 into a conductive paste for an external electrode including a conductive metal, but an embodiment thereof is not limited thereto.

As a more specific example of the first electrode layers 131a and 132a, the first electrode layers 131a and 132a may be fired electrode layers including a conductive metal and glass.

A material having excellent electrical conductivity may be used as the conductive metal included in the electrode layers 131a and 132a, and for example, the conductive metal may include one or more selected from a group consisting of nickel (Ni), copper (Cu), palladium (Pd), silver (Ag), gold (Au), platinum (Pt), tin (Sn), tungsten (W), titanium (Ti), and alloys thereof, but an example embodiment thereof is not limited thereto.

Also, glass included in the electrode layers 131a and 132a may improve bonding properties with the body 110.

The second electrode layers 131b and 132b may improve mounting properties and may be plating layers formed on the first electrode layers 131a and 132a by a plating method, but an embodiment thereof is not limited thereto.

The type of the second electrode layers 131b and 132b is not limited to any particular example and may include, for example, at least one of nickel (Ni), tin (Sn), silver (Ag), palladium (Pd) and alloys thereof.

The second electrode layers 131b and 132b may be a single layer or a plurality of layers.

More specifically, for example, the second electrode layers 131b and 132b may be a nickel (Ni) electrode layer or a tin (Sn) electrode layer, and a nickel (Ni) electrode layer and a tin (Sn) electrode layer may be formed in order on the first electrode layers 131a and 132a, or a tin (Sn) electrode layer, a nickel (Ni) electrode layer, and a tin (Sn) electrode layer may be formed in order. Also, the second electrode layers 131b and 132b may include a plurality of nickel (Ni) electrode layers and/or a plurality of tin (Sn) electrode layers.

The size of the multilayer electronic component 100 may not be limited to any particular example.

To obtain miniaturization and high capacitance simultaneously, the number of layers may need to be increased by reducing thicknesses of the dielectric layer and the internal electrode. Accordingly, when the average dimension in the second direction of the multilayer electronic component 100 is defined as L and the average dimension in the third direction of the multilayer electronic component 100 is defined as W, L≤0.4 mm and W≤0.2 mm may be satisfied. That is, the effect according to the present disclosure may be remarkable in the multilayer electronic component 100 having a size of 0402 (L×W: 0.4 mm×0.2 mm, L and W satisfy an error of +10%) or less.

The composite electronic component 10 according to an embodiment may include metal frames 201 and 202, and the metal frames 201 and 202 may include a first metal frame 201 and a second metal frame 202.

The metal frames 201 and 202 may include connection portions 201a and 202a disposed on the external electrodes 131 and 132, and support portions 201b and 202b connected to the connection portions 201a and 202a and spaced apart from the first surface 1.

Here, the configuration in which the connection portions 201a and 202a and the support portions 201b and 202b may be connected to each other is not limited to the structure in which the portions are directly connected to each other, and another component, for example, the connection portions 201c and 202c may be disposed between the connection portions 201a and 202a and the support portions 201b and 202b, such that the connection portions 201a and 202a and the support portions 201b and 202b may be indirectly connected to each other through the connection portions 201c and 202c.

More specifically, the first metal frame 201 may include a first connection portion 201a disposed on the first external electrode 131, and a first support portion 201b connected to the first connection portion 201a and spaced apart from the first surface 1, and may further include a third connection portion 201c disposed between the first connection portion 201a and the first support portion 201b and connecting the first connection portion 201a to the first support portion 201b.

The second metal frame 202 may include a second connection portion 202a, and a second support portion 202b connected to the second connection portion 202a and spaced apart from the first surface 1 on the second external electrode 132, and may further include a fourth connection portion 202c disposed between the second connection portion 202a and the second support portion 202b and connecting the second connection portion 202a to the second support portion 202b.

Unless otherwise indicated, the description of the metal frames 201 and 202 may be the description of the first and second metal frames 201 and 202, respectively, and similarly, the description of the connection portions 201a and 202a may be the description of the first and second connection portions 201a and 202a, respectively, the description of the support portions 201b and 202b may be the description of the first and second support portions 201b and 202b, respectively, and the description of the connection portions 201c and 202c may be the description of the third and fourth connection portions 201c and 202c, respectively.

The connection portions 201a and 202a may be disposed on the external electrodes 131 and 132.

Specifically, the connection portions 201a and 202a may be disposed on the external electrodes 131 and 132 so as to be in direct contact with the external electrodes 131 and 132, but an example embodiment thereof is not limited thereto, and conductive adhesives 301 and 302 may be further disposed between the connection portions 201a and 202a and the external electrodes 131 and 132, and the specific description thereof will be described later.

More specifically, the connection portions 201a and 202a may be disposed on the third and fourth surfaces 3 and 4 of the body 110, and more specifically, the first and second connection portions 201a and 202a may be disposed on the first and second external electrodes 131 and 132, respectively, which are disposed on the third and fourth surfaces 3 and 4. However, an example embodiment thereof is not limited thereto, and the portions may be disposed on the first surface 1 of the body, which may be the mounting surface, and more specifically, the portions may be disposed on the first and second external electrodes 131 and 132 extending to a portion of the first surface 1 and spaced apart from each other.

The support portion 201b and 202b may be spaced apart from the first surface 1, may be substantially parallel to the first surface 1, and also, the support portion 201b and 202b may be members mounted on the board 20.

The support portion 201b and 202b may have a substantially quadrangular shape, but preferably, an example embodiment thereof is not limited thereto, and the support portion 201b and 202b may have various shapes depending on the mounting circumstance.

In an embodiment, preferably, areas A1 and A2 of the support portions 201b and 202b may be a square value W² or more of the average dimension in the third direction W of the multilayer electronic component 100.

That is, the area A1 of the first support portion 201b may be a square value W² or more of the average dimension in the third direction W of the multilayer electronic component 100, and the area A2 of the second support portion 202b may be a square value W² or more of the average dimension in the third direction W of the multilayer electronic component 100. In other words, W²≤A1 and W²≤A2 may be satisfied.

For example, when the first support portion 201b and the second support portion 202b have a substantially quadrangular shape, and the average dimension in the second direction of the first support portion 201b is defined as L1, the average dimension in the third direction as W1, and the average dimension in the second direction of the second support portion 202b is defined as L2, the average dimension in the third direction as W², W²≤L1×W1 and W²≤L2×W² may be satisfied.

Hereinafter, the description of the area A1 of the first support portion 201b may also be applied to a product (L1×W1) of the average dimension in the second direction L1 and the average dimension in the third direction W1 of the first support portion 201b, and the description of the area A2 of the second support portion 202b may also be applied to a product L2×W2 of the average dimension in the second direction L2 and the average dimension in the third direction W² of the second support portion 202b.

As the area (A1, L1×W1) of the first support portion 201b and the area (A2, L2×W²) of the second support portion 202b satisfy W²<A1 (W²<L1×W1) and W²<A2 (W²≤L2×W²), mounting strength of an ultra-small multilayer electronic component 100, for example, the multilayer electronic component 100 having 0402 size or less, may be effectively improved and an excellent mounting ratio may be obtained.

When A1<W² (L1×W1<W²) or A2<W² (L2×W2<W²), mounting strength may not be sufficiently ensured, such that the mounting ratio may be reduced.

Upper limit values of the area (A1, L1×W1) of the first support portion 201b and the area (A2, L2×W²) of the second support portion 202b are not limited to any particular example, but the effect of improving mounting strength may be insignificant, and to prevent the mounting efficiency between adjacent components, upper limit values of the area (A1, L1×W1) of the first support portion 201b and the area (A2, L2×W2) of the second support portion 202b may be twice or less than the square value W² of the average dimension in the third direction W of the multilayer electronic component 100. In other words, W²≤A1≤2×W² W2≤L1×W1≤2×W² and W²≤A2≤2×W² W2≤L2×W^{2≤2}×W² may be satisfied.

The method of measuring the areas A1 and A2 of the support portions 201b and 202b is not limited to any particular example, and any device (e.g., electron microscope), method for measuring an area may be used to obtain the areas. More specifically, for example, in the case in which the support portions 201b and 202b have a substantially quadrangular shape, the dimensions in the second direction and the dimensions in the third direction may be measured at the center of each of the support portions, the dimensions in the second direction may be measured by being spaced apart from the center of the support portion in the third direction by a predetermined distance in both directions, the dimensions in the third direction may be measured by being spaced apart from the center of the support portion in the second direction by a predetermined distance in both directions, and by averaging the values, the average dimensions in the second direction L1 and L2 and the average dimensions in the third direction W1 and W2 may be obtained, and by multiplying the average dimensions in the second direction L1 and L2 and the average dimensions in the third direction W1 and W2 obtained as above, the areas A1 and A2 of the support portion 201b and 202b may be obtained. Other methods and/or tools appreciated by one of ordinary skill in the art, even if not described in the present disclosure, may also be used.

In an embodiment, the first and second support portions 201b and 202b may be spaced apart from each other in the second direction, and an average dimension in the second direction L3 of the distance at which the first and second support portions 201b and 202b are spaced apart from each other may be ½ or more than an average dimension in the second direction L of the multilayer electronic component 100. In other words, 0.5×L≤L3 may be satisfied.

Since the average dimension in the second direction L3 of the distance at which the first and second support portions 201b and 202b are spaced apart from each other satisfies 0.5×L≤L3, a target equivalent series resistance (ESR) value or less, and electrical properties may be designed, and electrical properties may be improved.

When L3<0.5×L, the equivalent series resistance (ESR) value may increase, such that electrical properties may deteriorate.

An upper limit value of the average dimension in the second direction L3 of the distance at which the first and second support portions 201b and 202b are spaced apart from each other is not limited to any particular example as long as the equivalent series resistance (ESR) may be reduced, but the effect of improving mounting strength may be insignificant, and to prevent the mounting efficiency between adjacent components, an upper limit value of the average dimension in the second direction L3 of the distance at which the first and second support portions 201b and 202b are spaced apart from each other may be the average dimension in the second direction L or less of the multilayer electronic component 100. In other words, 0.5×L≤L3≤L may be satisfied.

The average dimension in the second direction L3 of the distance at which the first and second support portions 201b and 202b are spaced apart from each other may be obtained from an electron micrograph by measuring the dimension in the second direction of the distance at which the first and second support portions 201b and 202b are spaced apart from each other based on the center in the third direction of the composite electronic component 10, measuring the dimensions in the second direction of the distance at which the first and second support portions 201b and 202b are spaced apart from each other from the center in the third direction of the composite electronic component 10 by a predetermined distance in both directions, and averaging the values, but an embodiment thereof is not limited thereto. Other methods and/or tools appreciated by one of ordinary skill in the art, even if not described in the present disclosure, may also be used.

As described above, the metal frames 201 and 202 may further include connection portions 201c and 202c disposed between the connection portions 201a and 202a and the support portions 201b and 202b and connecting the connection portions 201a and 202a to the support portions 201b and 202b.

The shape of the connection portions 201c and 202c is not limited to any particular example, and the connection portions 201c and 202c may have various shapes, such as a linear line or a curved line.

The connection portions 201c and 202c may disperse external stress transmitted from the support portions 201b and 202b to the connection portions 201a and 202a, or acoustic noise transmitted to the board 20, and accordingly, the connection portions 201c and 202c may reduce warpage stress applied to the multilayer electronic component 100 or acoustic noise generated by the multilayer electronic component 100 from being transmitted to the board 20.

Also, when a specific distance is formed between the connection portions 201a and 202a and the support portions 201b and 202b by including the connection portions 201c and 202c, the function of a solder pocket in which a solder SOL is accommodated may be performed.

As described above, in an embodiment, the composite electronic component 10 may further include conductive adhesive 301 and 302 disposed between the external electrodes 131 and 132 and the metal frames 201 and 202 and connecting the external electrodes 131 and 132 to the metal frames 201 and 202. More specifically, the conductive adhesive 301 and 302 may be disposed between the external electrodes 131 and 132 and the connection portions 201a and 202a and may connect the external electrodes 131 and 132 to the connection portions 201a and 202a.

The conductive adhesive 301 and 302 may include the first and second conductive adhesives 301 and 302, and more specifically, the first conductive adhesive 301 may be disposed between the first external electrode 131 and the first metal frame 201 and may connect the first external electrode 131 to the first metal frame 201, and the second conductive adhesive 302 may be disposed between the second external electrode 132 and the second metal frame 202 and may connect the second external electrode 132 to the second metal frame 202.

Unless otherwise indicated, the description of the conductive adhesive 301 and 302 may be the description of the first and second conductive adhesives 301 and 302, respectively.

The conductive adhesive 301 and 302 may be formed using any material having electrical conductivity, such as a metal, and a specific material may be determined by considering electrical properties, structural stability, or the like.

More specifically, for example, the conductive adhesive 301 and 302 may include one or more selected from a group consisting of nickel (Ni), copper (Cu), palladium (Pd), silver (Ag), gold (Au), platinum (Pt), tin (Sn), tungsten (W), titanium (Ti), and alloys thereof, but an example embodiment thereof is not limited thereto.

### Board for Mounting Composite Electronic Component

According to another embodiment, a board for mounting the composite electronic component 1000 may include a board 20; first and second electrode pads 31 and 32 disposed on the board 20; and the composite electronic component 10 described above; wherein the first and second support portions 201b and 202b may be mounted on the board 20 to be bonded to the first and second electrode pads 31 and 32, respectively.

In the embodiment, the description of the composite electronic component 10 overlaps the description of the composite electronic component 10 described above, and thus, a description thereof may not be provided.

The composite electronic component 10 may be connected to the first and second electrode pads 31 and 32 by solder SOL disposed on lower surfaces of the first and second support portions 201b and 202b, and the solder SOL may not rise to the first and second connection portions 201a and 202a, such that acoustic noise or vibrations generated from the composite electronic component 10 and transmitted to the board 20 may be reduced.

The board for mounting the composite electronic component 1000 in the embodiment may have no limitation in the mounting direction, and for example, the effect of addressing acoustic noise may be obtained in both cases in which the internal electrodes 121 and 122 laminated on the body 110 are laminated horizontally or vertically with respect to the mounting surface, or the internal electrodes 121 and 122 are laminated vertically.

Hereinafter, the present disclosure will be described in greater detail through experimental examples, but this is to help a specific understanding of the present disclosure, and the scope of the present disclosure is not limited to the experimental examples.

### Experimental Example

[Table 1] below lists the mounting ratio evaluated depending on the area of the support portion, and in this case, the support portion indicates the area of each of the first and second support portions, and the area of the support portion was calculated by multiplying the average dimension in the second direction and the average dimension in the third direction of the support portion. The multilayer electronic component corresponding to the sample chip was manufactured in the size of 0402 (L×W: 0.4 mm×0.2 mm).

100 sample chips were manufactured for each experimental example, and the number of sample chips without mounting defects among the total sample chips was converted into a percentage and listed.

TABLE 1

| | Area of support portion | |
|---|---|---|
| | (mm²) | Mounting ratio (%) |
| Experimental example 1 | 0.01 mm² | 4.5% |
| Experimental example 2 | 0.02 mm² | 19.8% |
| Experimental example 3 | 0.03 mm² | 26.8% |
| Experimental example 4 | 0.04 mm² | 91.4% |
| Experimental example 5 | 0.05 mm² | 93.5% |

The mounting ratios in experimental example 1 to experimental example 3, in which the area of the support portion was less than 0.04 mm², which is the square W² of the average dimension in the third direction of the multilayer electronic component having a 0402 size, were 4.5%, 19.8%, and 26.8%, respectively, which were not excellent mounting ratios. On the other hand, the mounting ratios in experimental example 4 and experimental example 5, in which the area of the support portion was 0.04 mm² or more, which was the square W² of the average dimension in the third direction of the multilayer electronic component having a 0402 size, were 91.4% and 93.5%, respectively, which are excellent mounting ratios, and the area of the support portion was rapidly improved based on the square W² value of 0.04 mm², which is the average dimension in the third direction of the multilayer electronic component. Accordingly, when the area of each support portion was the square value or more of the average dimension in the third direction of the multilayer electronic component, mounting properties were improved.

[Table 2] below lists the minimum and maximum values of the equivalent series resistance (ESR) according to the distance L3 at which the first and second support portions were spaced apart from each other in the second direction, and the average values (rounded to the third decimal place) thereof were calculated and listed. The multilayer electronic component corresponding to the sample chip was manufactured in the size of 0402 (L×W: 0.4 mm×0.2 mm).

The equivalent series resistance (ESR) of the manufactured 0402-sized multilayer electronic component was measured using an LCR meter (keysight E4980A equipment), and was measured using the SMD Fixture type probe method. In this case, the calibration mode was set to FUNC→R-X, and the cursor was placed on FREQ, and the values were measured repeatedly by repeating Probe close→MEAS SHORT and Probe open→MEAS OPEN until the values became constant at the minimum value.

TABLE 2

| | L3 (mm) | | Minimum ESR (Ω) | | Maximum ESR (Ω) | | Average ESR (Ω) | |
|---|---|---|---|---|---|---|---|---|
| Experimental example | 0.8 | mm | 27.97 | Ω | 30.20 | Ω | 28.90 | Ω |
| 6 | | | | | | | | |
| Experimental example | 0.12 | mm | 26.17 | Ω | 29.27 | Ω | 28.9 | Ω |
| 7 | | | | | | | | |
| Experimental example | 0.16 | mm | 15.81 | Ω | 18.17 | Ω | 17.17 | Ω |
| 8 | | | | | | | | |
| Experimental example | 0.2 | mm | 4.92 | Ω | 7.30 | Ω | 6.03 | Ω |
| 9 | | | | | | | | |
| Experimental example | 0.24 | mm | 4.12 | Ω | 7.67 | Ω | 5.27 | Ω |

10

The average ESR values in experimental example 6 to experimental example 8, in which the distance L3 at which the first and second support portions were spaced apart from each other in the second direction was less than 0.2 mm, which was 0.5 times the average dimension in the second direction L of the multilayer electronic component having 0402 size, were 28.90 Ω, 28.9Ω, and 17.17Ω, respectively, which exceeded the target ESR value of 10Ω, but the average ESR values in experimental example 9 and experimental example 10, in which the distance L3 at which the first and second support portions are spaced apart from each other in the second direction was 0.2 mm or more, which was 0.5 times the average dimension in the second direction L of the multilayer electronic component having the 0402 size, were 6.03Ω and 5.27Ω, respectively, which satisfied the target ESR value of 10Ω or less, and the distance L3, at which the first and second support portions were spaced apart from each other in the second direction, was rapidly improved from 0.2 mm, which was 0.5 times the average dimension in the second direction L of the multilayer electronic component. Accordingly, ESR properties was improved when the distance L3 at which the first and second support portions were spaced apart from each other in the second direction was 0.5 times or more the average dimension in the second direction L of the multilayer electronic component.

According to the aforementioned embodiments, warpage strength of the composite electronic component may improve.

Also, mounting strength of the composite electronic component may improve.

Also, equivalent series resistance (ESR) of the composite electronic component may improve.

Also, acoustic noise of the composite electronic component may be reduced.

The embodiments do not necessarily limit the scope of the embodiments to a specific embodiment form. Instead, modifications, equivalents and replacements included in the disclosed concept and technical scope of this description may be employed. Throughout the specification, similar reference numerals are used for similar elements.

In the embodiments, the term “embodiment” may not refer to one same embodiment, and may be provided to describe and emphasize different unique features of each embodiment. The suggested embodiments may be implemented do not exclude the possibilities of combination with features of other embodiments. For example, even though the features described in an embodiment are not described in the other embodiment, the description may be understood as relevant to the other embodiment unless otherwise indicated.

Terms used in the present specification are for explaining the embodiments rather than limiting the embodiments. Unless explicitly described to the contrary, a singular form may include a plural form in the present specification.

While the embodiments have been illustrated and described above, it will be configured as apparent to those skilled in the art that modifications and variations could be made without departing from the scope of the present disclosure as defined by the appended claims.

What is claimed is:

1. A composite electronic component, comprising:
a multilayer electronic component including:
a body including a dielectric layer and internal electrodes alternately disposed with the dielectric layer in a first direction, and first and second surfaces opposing each other in the first direction, third and fourth surfaces connected to the first and second surfaces and opposing each other in a second direction, fifth and sixth surfaces connected to the first to fourth surfaces and opposing each other in a third direction, and
first and second external electrodes disposed on the third and fourth surfaces, respectively;
a first metal frame including:
a first connection portion disposed on the first external electrode, and
a first support portion connected to the first connection portion and spaced apart from the first surface; and
a second metal frame including:
a second connection portion disposed on the second external electrode, and
a second support portion connected to the second connection portion and spaced apart from the first surface,
wherein, when an average dimension, in the second direction, of the multilayer electronic component is defined as L and an average dimension, in the third direction, of the multilayer electronic component is defined as W, L≤0.4 mm, W≤0.2 mm is satisfied, and
wherein, when an area of the first support portion is defined as A1 and an area of the second support portion is defined as A2, W²≤A1 and W²≤A2 is satisfied.

2. The composite electronic component of claim 1, wherein W, A1, and A2 satisfy W²≤A1≤2×W² and W²≤A2≤2×W².

3. The composite electronic component of claim 1, wherein the first and second support portions are spaced apart from each other in the second direction, and when an average dimension, in the second direction, of a distance between the first and second support portions is defined as L3, 0.5×L≤L3 is satisfied.

4. The composite electronic component of claim 3, wherein L and L3 satisfy 0.5×L≤L3≤L.

5. The composite electronic component of claim 1,
wherein the first metal frame further includes a third connection portion disposed between the first connection portion and the first support portion, and connecting the first connection portion to the first support portion, and
wherein the second metal frame further includes a fourth connection portion disposed between the second connection portion and the second support portion, and connecting the second connection portion to the second support portion.

6. The composite electronic component of claim 5, wherein the third connection portion is inclined with respect to the first connection portion.

7. The composite electronic component of claim 5, wherein the third connection portion includes a curved portion.

8. The composite electronic component of claim 7, wherein, as viewed from a side of the multilayer electronic component in the second and third directions, the curved portion is concave.

9. The composite electronic component of claim 7, wherein, as viewed from a side of the multilayer electronic component in the second and third directions, the curved portion is convex.

10. The composite electronic component of claim 1, further comprising:
a first conductive adhesive disposed between the first external electrode and the first metal frame and connecting the first external electrode to the first metal frame, and
a second conductive adhesive disposed between the second external electrode and the second metal frame and connecting the second external electrode to the second metal frame.

11. A composite electronic component, comprising:
a multilayer electronic component including:
a body including a dielectric layer and internal electrodes alternately disposed with the dielectric layer in a first direction, and first and second surfaces opposing each other in the first direction, third and fourth surfaces connected to the first and second surfaces and opposing each other in a second direction, fifth and sixth surfaces connected to the first to fourth surfaces and opposing each other in a third direction, and
first and second external electrodes disposed on the third and fourth surfaces, respectively;
a first metal frame including:
a first connection portion disposed on the first external electrode, and
a first support portion connected to the first connection portion and spaced apart from the first surface; and
a second metal frame including:
a second connection portion disposed on the second external electrode, and
a second support portion connected to the second connection portion and spaced apart from the first surface,
wherein, when an average dimension, in the second direction, of the multilayer electronic component is defined as L and an average dimension, in the third direction, of the multilayer electronic component is defined as W, L≤0.4 mm, W≤0.2 mm is satisfied, and
wherein, when an average dimension, in the second direction, of the first support portion is defined as L1, an average dimension, in the third direction, of the first support portion is defined as W1, an average dimension, in the second direction, of the second support portion is defined as L2, and an average dimension, in the third direction, of the second support portion is defined as W², W²≤L1×W1 and W²≤L2×W² is satisfied.

12. The composite electronic component of claim 11, wherein W, L1, W1, L1, and W² satisfy W²≤L1×W1≤2×W² and W²≤L2×W^{2≤2}×W².

13. The composite electronic component of claim 11, wherein the first and second support portions are spaced apart from each other in the second direction, and when an average dimension, in the second direction, of a distance between the first and second support portions is defined as L3, 0.5×L≤L3 is satisfied.

14. The composite electronic component of claim 13, wherein L and L3 satisfy 0.5×L≤L3≤L.

15. The composite electronic component of claim 11,
wherein the first metal frame further includes a third connection portion disposed between the first connection portion and the first support portion and connecting the first connection portion to the first support portion, and
wherein the second metal frame further includes a fourth connection portion disposed between the second connection portion and the second support portion and connecting the second connection portion to the second support portion.

16. The composite electronic component of claim 11, further comprising:
a first conductive adhesive disposed between the first external electrode and the first metal frame and connecting the first external electrode to the first metal frame, and
a second conductive adhesive disposed between the second external electrode and the second metal frame and connecting the second external electrode to the second metal frame.

17. A board for mounting the composite electronic component, the board comprising:
a board;
first and second electrode pads disposed on the board; and
the composite electronic component of claim 1,
wherein the first and second support portions are mounted on the board to be bonded to the first and second electrode pads, respectively.
